(19) United States
(12) Patent Application Publication
(10) Pub. No.: US 2021/0213624 A1
(43) Pub. Date: Jul. 15, 2021

(54) DEVICE FOR NON-CONTACT OBJECT HANDLING

(71) Applicant: TOUCHLESS DEVELOPMENT GMBH, BIEL/BIENNE (CH)

(72) Inventors: Fabio Depetris, Biel/Bienne (CH); Mike Sabato, Port (CH)

(73) Assignee: TOUCHLESS DEVELOPMENT GMBH, BIEL/BIENNE (CH)

(21) Appl. No.: 17/059,943

(22) PCT Filed: Jun. 1, 2018
(86) PCT No.: PCT/EP2018/064463

§ 371 Date: Nov. 30, 2020

(51) Int. Cl. B25J 15/06; B06B 1/00

(52) U.S. Cl. CPC B25J 15/0616; B25J 15/0052; B06B 1/00

(57) ABSTRACT

A non-contact handling tool for gripping an object, the tool comprising an ultrasound transducer extending between a reflective face and a gripping face configured to emit ultrasound forming, in a near field area of the gripping face, an over-pressure wave, and a fluid suction system configured to suction a fluid towards the gripping face, forming in said near field area an under-pressure. The fluid suction system comprises at least one fluid suction channel disposed in the ultrasound transducer. The ultrasound transducer is configured to operate at a frequency corresponding to the first harmonic resonant frequency of the transducer or at a forced anti-resonant frequency near the first harmonic frequency.

### TECHNICAL FIELD

The present invention relates to a device for non-contact handling of an object and a method for non-contact handling of an object. The invention relates more particularly to a device for handling of small objects having a size in particular less than a volume on the order of 10⁻⁶ m³ or less than a mass on the order of 20 gm.

### STATE OF THE ART

Methods called “pick and place” methods allow handling an object by using tools that perform handlings at extremely high rates to move several hundred objects per minute. The “Pick and place” tools generally use sucking devices, called “vacuum grippers”, to suction the object in a direction opposite to gravity, immobilize the object against the tool and thus move it to the desired location. When it comes to handling objects on the order of one centimeter, the aim is to grip the object while fighting the effects of gravity. For this range of objects, gravity is the main force exerted on the object, gravity being in particular much greater than the adhesion forces between the tool and the object.

However, when the size of the object decreases, typically below 10⁻⁶ m³, the gravity exerted on the object is very low and it is easy to suction the object. On the other hand, the adhesion forces, which were negligible for larger objects, become the majority and are much greater than gravity. Thus, when the object is pressed against the tool, it is difficult to detach the object from the tool because of the adhesion forces between the object and the tool, which disrupts the speed of movement and the accuracy of the positioning of the moved object. In addition, at this scale, each contact between the object and the sucking head may damage the object by generating micro-particles which can also disrupt the operation of the tool. Thus, the sucking devices are not satisfactory for handling small-sized objects or fragile objects.

To overcome the drawbacks of the sucking devices, there are non-contact methods, where the object to be moved levitates above or below the tool.

Optical levitation that allows accelerating and suspending a particle up to 10⁻¹² m³ by applying a radiation pressure, for example by a laser radiation, is known. However, this type of handling must be done in a transparent environment to optimize the stability of the particle, the particle being necessarily a transparent dielectric particle.

There is also the electric levitation that uses an electric field to counter gravity and handle a charged or polarized object. It is possible to replace the electric field with a magnetic field to handle objects according to their magnetic properties. However, these two types of levitation are only applicable to objects sensitive to electric or magnetic fields. In addition, there is a risk of damage to the object placed in a magnetic or electric field. Finally, these techniques require specific installations depending on the object to be handled.

The aerodynamic levitation uses a gas flow, generally air, to levitate an object. In this type of levitation, distinction is made between the air bearings and the Bernoulli devices. The air bearings expel air flow from below the object to make it levitate. Conversely, The Bernoulli devices are positioned above the object to be handled. In the Bernoulli devices, the tool comprises side walls, with the object to be handled being positioned between these walls. The tool comprises a channel that expels compressed air on the object. The compressed air projected on the object is discharged through the space between the walls and the object, which generates an attraction force opposite to the direction of the compressed air, this effect being called Bernoulli Effect. The attractive force allows keeping the object away from the tool. The main disadvantage of the aerodynamic methods is that the levitating object has very little lateral stability.

Levitation methods using ultrasound are also known. Distinction is made between the methods using the standing wave levitation or the far field levitation and the methods using the near field levitation. The transition between the near field and the far field takes place at a point F called natural focus. The natural focus F is a distance from the surface of the ultrasound wave generator: before F, it is the near field, after F, it is the far field. In other words, if an object is levitating in a near field, it is the near field levitation, if it is levitating after point F, it is said that the object is levitating in the far field. F is defined by:

F=r\hat{ }2/λ

where r is the radius of the surface of the portion of the generator opposite to the object and A is the wavelength of the ultrasound.

The systems using the standing wave levitation require the presence of a reflector that faces the ultrasound generator. The generator emits waves that will be reflected on the reflector and create nodes equidistant by λ/2 where the repulsion force is sufficient for an object to be able to levitate. The main drawback of this technique is that the handlings are limited to the area between the generator and the reflector, and those only at the nodes. In addition, the object must be kept at a minimum distance from the generator by λ/2 which is the distance from the first node.

In some methods using the near field ultrasound, there is no reflector facing the emitter, it is the object to be levitated that acts as a reflector. This method is little used because its field of application is limited to a vertical movement of the object, from bottom to top, by placing an emitter below the object, which restricts its field of application.

Levitation methods using a combination of ultrasound and air suction are also known, and described for example in the documents “Non-contact Handling and Transportation for Substrates and Microassembly Using Ultrasound-Air-Film-Technology”, IEEE 2011, US2004/0070221, DE102008036805, and JP2006-073654. In these devices of the prior art, a sonotrode integrating the suction channel is coupled to a transducer, the sonotrode corresponding to at least one half wavelength, sometimes more, adding to the length of the transducer corresponding at least one half wavelength. The tools of the prior art have a length between ends of at least one wavelength of the ultrasound generated in the body of the tool. The space requirement of such tools for applications for gripping and placing or other applications for handling objects in restrictive spaces, is a drawback and sometimes makes the use of such tools impossible for some applications. Furthermore, an increased mass of the tool can also negatively affect the performance (speed and accuracy) of the robot machines carrying these tools.

In practice, conventional levitation tools using a combination of ultrasound and air suction would pose stability problems in gripping and placing millimetric or micrometric objects due to the relatively high amplitude of the repulsion and sucking forces at the balance point at a distance very close to the object. Difficulties are increased when gripping the object from a surface by the tool, and also when releasing the object to its target position due to the influence of the surface on which the object is laid on the air steam and the pressure. There may also be significant electrostatic forces to overcome for small objects.

### BRIEF SUMMARY OF THE INVENTION

One aim of the present invention is to propose a system for non-contact handling of an object, particularly a millimetric or micrometric object, free from the limitations or minimizing the limitations of the known devices.

Aims of the invention are achieved by a tool according to claim 1, a system according to claim 13, and a method according to claim 20.

Hereby, a non-contact handling tool for gripping an object is described, the tool comprising an ultrasound transducer configured to emit ultrasound forming, in a near field area of a gripping face of the transducer, an over-pressure wave and a fluid suction system configured to suction a fluid towards the gripping face, forming in said near field area an under-pressure.

According to a first aspect of the invention, the ultrasound transducer is configured to operate at a frequency corresponding to the first harmonic resonant frequency of the transducer or at a forced anti-resonant frequency near the first harmonic frequency.

In one advantageous embodiment, the ultrasound transducer extends between a reflective face and the gripping face, a height of the transducer defined by a distance between the gripping face and the reflective face ranging from 80% to 150% of one half wavelength λ/2 of the ultrasound generated in the transducer.

In one advantageous embodiment, the fluid suction system comprises at least one fluid suction channel disposed in the ultrasound transducer.

In one advantageous embodiment, the ultrasound transducer includes a body and a head, disposed at one end of the body opposite to the reflective face, the head comprising the gripping face and being separable from the body, said at least one suction channel passing through the body and the head.

In one advantageous embodiment, the ultrasound generator comprises at least one pair of superimposed piezoelectric, preferably piezoceramic, elements, said pair being screwed into the body by a screw, the suction channel passing through the screw.

In one advantageous embodiment, said height of the transducer ranging from 90% to 110% of one half wavelength λ/2 of the ultrasound generated in the transducer.

In one advantageous embodiment, said height of the transducer is less than 100 mm, preferably less than 90 mm, for example ranging from 90 mm to 20 mm.

In one advantageous embodiment, the suction channel comprises one or more suction nozzle(s) opening onto the gripping face. In one variant, the suction channel comprises a single suction nozzle opening out onto the gripping face, said suction nozzle being centered on the gripping face. In another variant, the suction channel comprises several suction nozzles opening out onto the gripping face.

In one advantageous embodiment, said at least one suction channel passes through the handling tool from the gripping face to the reflective face.

In one advantageous embodiment, the ultrasound transducer comprises an ultrasound generator and an ultrasound transmission device coupled to the generator, the transmission device comprising a front body provided with an element for fastening the tool disposed at a first nodal plane of the ultrasonic waves generated in the transducer at a frequency corresponding to the first harmonic resonant frequency of the transducer or at a forced anti-resonant frequency near the first harmonic frequency.

In one advantageous embodiment, the ultrasound transducer comprises a head interchangeably coupled to a front body of the transmission device by a fastening device, the gripping face being disposed on the head, a second nodal plane of the ultrasonic waves generated in the transducer at a frequency corresponding to the first harmonic resonant frequency of the transducer or at a forced anti-resonant frequency near the first harmonic frequency, being located at said fastening device.

In one advantageous embodiment, the transmission device comprises a rear body and a prestressing member, the ultrasound generator being compressed between the front body and the rear body by the prestressing member. The prestressing member can in particular be a screw, and in an advantageous embodiment, the suction channel passes through the screw.

According to one embodiment, the ultrasound generator can comprise a stack of a plurality of piezoelectric rings. According to one embodiment, there are 2 piezoelectric rings. According to variants, there are 4 or 6 piezoelectric rings.

In one advantageous embodiment, the ultrasound transducer comprises a head interchangeably coupled to a front body of the transmission device, the gripping face being disposed on the head. The tool may comprise a set of several interchangeable heads of different dimensions or shapes.

In one advantageous embodiment, the head and the front body comprise complementary fastening elements in the form of a bayonet or screw fastening system.

According to embodiments, the gripping face may be planar or curved, for example having a concave shape, configured to conform to a portion of the surface of the object to be gripped.

According to embodiments, the gripping face may comprise a hydrophobic or lipophobic surface, in particular for applications for gripping liquid objects.

In one advantageous embodiment, the tool may further comprise an electric discharge device for neutralizing an electric charge of the object.

The surface of the gripping face within the framework of the invention can be ranging from 0.1 to 1,300 mm².

In one advantageous embodiment, the gripping face of the tool has a surface of a size identical, or ranging from 90% to 110%, to the size of a surface of the object to be gripped.

In one advantageous embodiment, the front body comprises at least two successive diameter reductions D1, D2, D3 in the direction of the ultrasound generator towards the gripping face, the ratios between the successive diameters D1, D2, D3 in said direction ranging:
for D1/D2, between max 2.6 and min 1.1
for D2/D3, between max 6 and min 1.1

and for any additional reduction between max 6 and min 1.1.

Hereby, a non-contact handling system is also described, comprising the non-contact handling tool, a control unit connected to the ultrasound generator of the ultrasound transducer, and a suction device comprising a suction pump connected to the fluid suction channel. The control unit and the ultrasound transducer are configured to generate ultrasound in the transducer at a frequency corresponding to the first harmonic resonant frequency of the transducer or at a forced anti-resonant frequency near the first harmonic frequency.

In one advantageous embodiment, the control unit and the ultrasound transducer are configured to generate ultrasound at a frequency ranging from 20 kHz to 350 kHz depending on the size of the object to be handled.

In one advantageous embodiment, the control unit and the ultrasound transducer are configured to generate ultrasound at a frequency ranging from 30 kHz to 350 kHz, and in particular ranging from 40 kHz to 300 kHz.

In one advantageous embodiment, the control unit comprises a control circuit connected to the ultrasound generator and to the suction pump for simultaneously controlling the suction power and the ultrasound generation.

In one advantageous embodiment, the suction device comprises a solenoid valve and a pressure sensor connected to the control unit, the solenoid valve being regulated by the pressure measured by the pressure sensor in order to regulate the distance of suspension dₛ of the object relative to the gripping face.

In one advantageous embodiment, the system comprises a pressure stabilizer fluidly coupled to the suction channel to detect that an under-pressure threshold has been exceeded in order to avoid sucking of foreign matter coming from the object in nozzles or in the suction channel.

In one advantageous embodiment, the pressure stabilizer comprises or consists of a resistive orifice which is configured to provide resistance to air flow greater than the suction channel. In particular, the resistance to air flow is at least twice greater than the resistance to air flow generated by the suction channel together with the nozzle(s). Preferably, the resistance to air flow is at least three times greater, even at least four times greater than the resistance to air flow generated by the suction channel together with the nozzle(s).

In one advantageous embodiment, the system comprises a flow sensor measuring the air flow in the suction channel connecting the tool to the suction pump, the flow detector configured to detect the contact of the object with the gripping face or to detect too high flow indicating that the object is no longer in engagement with the tool.

Hereby, a method for non-contact handling of an object is also described, comprising:
providing a non-contact handling system comprising a non-contact handling tool, a control unit connected to an ultrasound generator of the ultrasound transducer, and a suction device comprising a suction pump connected to the fluid suction channel, the control unit and the ultrasound transducer being configured to generate ultrasound in the transducer at a frequency corresponding to the first harmonic resonant frequency of the transducer or at a forced anti-resonant frequency near the first harmonic frequency;
activating the suction pump to create a suction force and the ultrasound generator to create a repulsion force, relative to the gripping face,
placing the gripping face of the handling tool in front of a surface of the object,
suspending the object at a non-zero suspension distance with respect to the gripping face by controlling the suction device or the ultrasound generator, or both simultaneously, the suspension distance being controlled to be in a near field area of the ultrasound.

In one advantageous embodiment, the distance of suspension of the object relative to the gripping face is between 1 and 80 micrometers, preferably between 1 and 60 micrometers.

The device according to the present invention uses near field ultrasound as a repulsive force. Indeed, the repulsive force of the ultrasound varies in the Fresnel area so as to follow the relation 1/(x²) as a function of the distance x to the head, as illustrated in FIG. 11c. This graph illustrates that the force is maximum nearest to the head, that is to say at the level of the near field ultrasound (area 1 in FIG. 2), then decreases in the standing waves (area 2 in FIG. 2). The near field repulsion force is always greater than the force measured at the nodes separated by λ/2 in the standing wave levitation area. Thus, the use of the near field ultrasound allows using a maximum repulsive force on the object, which is counterbalanced by an attractive force on the same order, which allows obtaining a maximum levitation force on the object. This allows improving the stability of the object during the suspension of the object.

In one embodiment, the ultrasound generator generates ultrasound at a frequency between 20 kHz and 500 kHz, preferably between 40 kHz and 300 kHz as a function of the size of the object to be gripped. The frequency depends on the dimensions of the object to be handled. The smaller the object, the higher the frequency can be, and vice versa.

In one embodiment, the head has a diameter of about three times the diameter of the object.

In one embodiment, the height h of the body-head assembly is less than eight times, for example about six times, the diameter of the shell of the object. For example, to handle an object of about 3 mm in diameter, the length of the body-head assembly is of about 20 mm and the maximum diameter of the head is of about 8 mm.

The term “diameter” has a broad definition to refer to the largest dimension of the object (its shell) disposed facing the gripping face of the head, and is also applied here to the heads or to the non-circular objects in this plane.

Advantageously, it is possible to miniaturize the device of the handling system to adapt the dimensions of the body and of the head according to the object to be handled.

The invention works with objects having a planar surface or a spherical surface as well as with objects having openings. Particularly, the best centering or alignment results are obtained when the surface of the object facing the gripping face is a continuous surface, without holes or openings.

The object of the system has no size or shape restriction, it can be planar, spherical or include concave or convex sides, or openings. The object can be a solid object which can consist of all types of materials. For example, the materials are chosen among metal or a metal alloy, ceramics, polyolefins, polyamides, resins, for example epoxy, glass, silicon, plastic polymers.

For example, the object is chosen among electronic components such as semiconductors, MEMS or MOEMS-type microsystems, biochips, thin-film transistors, chips or other electronic components. The object may have a glass coating, a pre-machined coating that has hollows or reliefs. The object can be a timepiece, like the parts that make up a motion. The object can be a component used to manufacture medical devices in the medical or pharmaceutical technologies. The object can be a component used to manufacture compounds in aerospace.

The object is chosen among the objects moved by micro-handling, handling of the fragile objects, handling of the objects without contamination.

For example, the object can have a weight from 0.1 milligrams to 10 grams and a diameter from 0.2 mm to 40 mm.

In one embodiment, the device allows maintaining a gap (also called suspension distance) between 1 and 80 micrometers, preferably between 5 and 60 micrometers between the gripping face and the surface of the object opposite to said gripping face. The distance may depend on the dimensions of the object, in particular the smaller the object, the smaller the distance can be.

Other aims and advantageous aspects of the invention will become apparent upon reading the detailed description of embodiments and the drawings.

### BRIEF DESCRIPTION OF THE DRAWINGS

FIG. 1a is a schematic view of a system for non-contact handling of an object according to one embodiment of the invention;

FIG. 1b is a schematic view of a portion of a system for non-contact handling of an object according to one embodiment of the invention;

FIG. 2a is a sectional view of a non-contact handling tool according to one embodiment of the invention, a head of the tool being disassembled from the body of the tool;

FIG. 2b is a sectional view of a non-contact handling tool according to one embodiment of the invention, showing the head assembled to the body, and with a connection portion of the suction system mounted on the tool;

FIG. 2c is a perspective view of a non-contact handling tool according to one embodiment of the invention, with a connection portion of the suction system mounted on the tool and comprising an electric discharge system;

FIG. 2d is a perspective view similar to FIG. 2c, with a separate electric discharge system according to one variant;

FIG. 3a is a perspective view of separable body and head of a non-contact handling tool according to a first embodiment of the invention;

FIG. 3b is a sectional view in a plane crossing the axis of the assembled parts of FIG. 3b and FIG. 3c is a sectional view along the line G-G of FIG. 3b,

FIG. 3d is a detailed view of a coupling portion of the head of FIG. 3a;

FIG. 4 is a perspective view of a separable head of a non-contact handling tool according to a second embodiment of the invention;

FIG. 5a is a perspective view of a separable head of a non-contact handling tool according to a third embodiment of the invention;

FIG. 5b is a detailed partial view of a gripping face of the head of FIG. 5a;

FIG. 6 is a perspective view of a separable head of a non-contact handling tool according to a fourth embodiment of the invention;

FIG. 7a is a perspective view of a separable head of a non-contact handling tool according to a fifth embodiment of the invention;

FIG. 7b is a view of a gripping face of the head of FIG. 7a;

FIG. 8a is a perspective view of a separable head of a non-contact handling tool according to a sixth embodiment of the invention;

FIG. 8b is a side view of the head of FIG. 8a;

FIG. 9a is a perspective view of a head of a non-contact handling tool according to a seventh embodiment of the invention;

FIG. 9b is a view of a gripping face of the head of FIG. 9a;

FIG. 10 is a schematic illustration illustrating the alignment of an object relative to the head of a tool;

FIG. 11a schematically illustrates the repulsion and suction forces on an object located at a distance near the gripping face of the tool;

FIG. 11b illustrates a graph showing the repulsion force due to ultrasonic waves as well as the suction force on an object as a function of the distance separating the object from the gripping face of the tool;

FIG. 11c is a schematic graph of the repulsion force created by an ultrasonic wave as a function of the distance from an emitting surface;

FIG. 12a is a graph illustrating the relation between the height of the transducer as a function of the fundamental resonant frequency of the transducer, and FIG. 12b is a graph illustrating the relation between the height of the transducer as a function of the size of the object to be gripped.

FIG. 13 illustrates the profile of the amplitude of a wave as a function of the axial position in the tool for a frequency of the generator corresponding to the first harmonic frequency of the transducer;

FIG. 14 illustrates an electrical impedance curve as a function of the frequency of the generator of a transducer of a non-contact handling tool according to one embodiment of the invention.

### DESCRIPTION OF EMBODIMENTS OF THE INVENTION

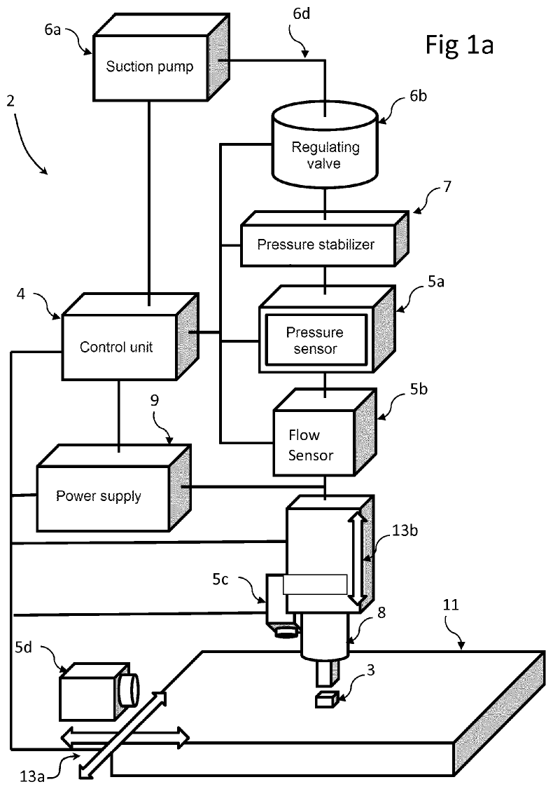

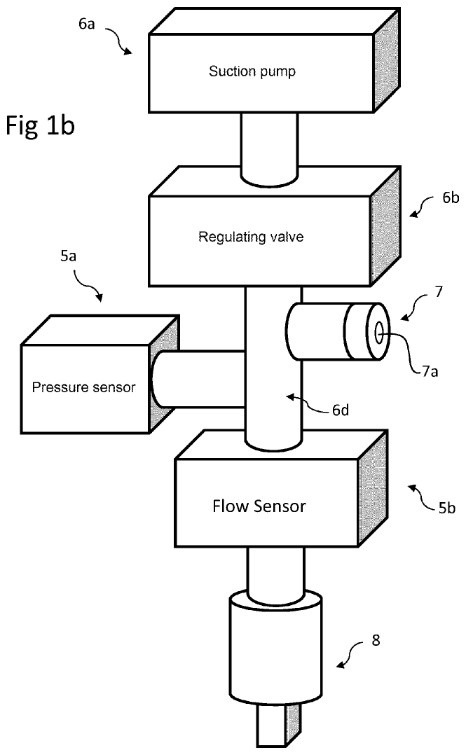

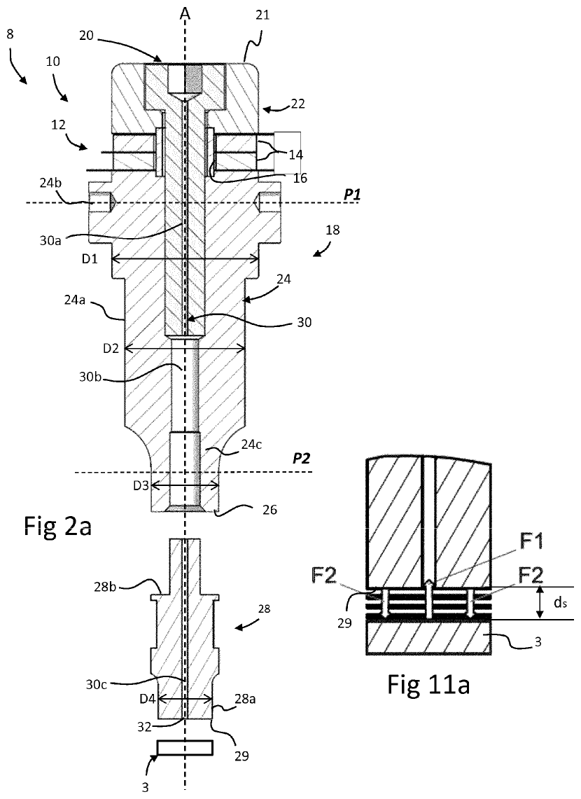

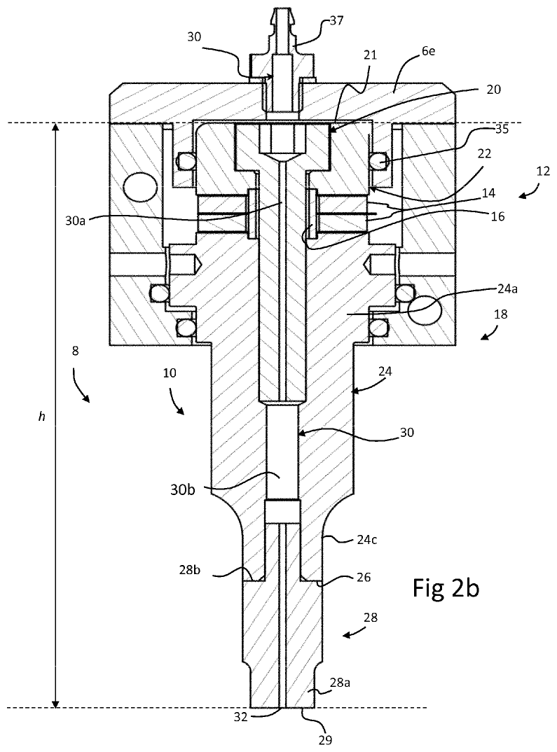

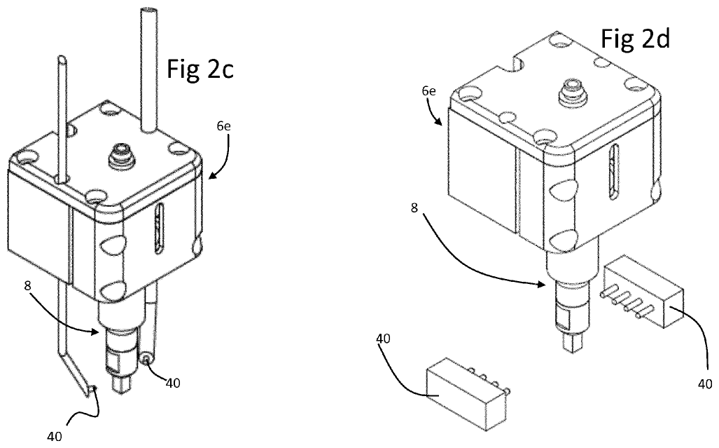

Referring to the figures, in particular FIGS. 1, 2a, and 2b, a handling system 2, according to one embodiment of the invention, is illustrated. The handling system 2 is in particular configured for gripping and placing an object 3 without coming into direct contact with the object. The handling system 2 according to embodiments of the invention is configured for handling small objects, in particular objects having a mass of less than 20 grams, even less than 10 grams. The handling system 2 according to embodiments of the invention is very advantageously configured for handling very small objects and in particular objects having a mass of less than 1 g up to 0.01 milligrams.

The non-contact handling system according to embodiments of the invention is in particular configured to be integrated into an assembly machine, in particular a robot for assembling micro-components in a product manufacturing line. Examples of non-exhaustive applications comprise:
gripping-placing on a circuit board small electronic components such as semiconductors, MEMS or MOEMS type micro-systems, biochips, thin-film transistors, chips or other electronic components;
gripping semiconductor chips directly from a semiconductor wafer;
gripping small components on an adhesive support;
handling small electronic components for various operations such as inspection, quality control, packaging or assembly;
handling micro-mechanical parts for small motors;
handling timepieces, such as the parts that make up a motion, the dial, hands, appliques, glass, for example for the assembly of parts, the handling of parts after diamond coating, the surface treatment or for the quality control and the inspection;
handling components used to manufacture compounds in aerospace;
handling components used to manufacture medical devices;
handling components used in medical or pharmaceutical technologies.
handling small living organisms, for example within a liquid droplet, embryos, nematodes in or out of water.

In many applications where the micro-components have masses of less than 10 gm, even less than 1 gram, for the assembly in products of restricted volume or inside restricted volumes, the space requirement of the handling tool has a significant consequence. Indeed, the smaller the space requirement of the tool, the more versatility there is in the use of the tool and in particular for placing products in confined spaces, restricted openings and other constraints in the movement of a tool relative to other tools or portions of the product in which the components are assembled.

In addition, a reduction in the size and mass of the tool allows faster movement since the inertia of the tool is reduced, thus increasing the tool handling performances, for example for the assembly of components.

The use of a non-contact handling system allows avoiding the problems related to contact handling tools, among other things:
the risk of damaging the component
the problems with adhesion of a small-sized object and not being able to easily let go of the object,
the difficulty of gripping and placing a small-sized object with sufficient accuracy or control,
the risk of contaminating the component.

According to one embodiment, the non-contact handling system 2 comprises a control unit 4, a suction device 6 and a non-contact handling tool 8. The suction device comprises a suction pump 6a coupled to the handling tool via a channel 6d for suctioning a fluid, in particular a gas, through the non-contact handling tool. The suction device may further comprise a regulating valve 6b and sensors, in particular a pressure sensor 5a and a flow sensor 5b. The control unit 4 comprises a power supply 9 and a control circuit with a microprocessor for controlling an ultrasound generator in the handling tool as will be described in more detail below. The control unit can also be connected to the suction system, in particular the suction pump 6a and/or the regulating valve 6b. The control unit allows in particular controlling the gripping and the dropping of the object 3 by the non-contact handling tool 8.

The control unit 4 is illustrated as being a single control unit but in the case of the invention, it is of course possible to have several control units which can be connected together for the control of various devices such as the suction device 6, the non-contact handling tool 8 and a placement table 11 on which the object 3 is laid.

The suction device 6 can comprise the suction pump 6a connected to the regulating valve 6b as well as a pressure stabilizer 7 and one/or more sensors, in particular a pressure sensor 5a and a flow sensor 5b. The regulating valve 6b can comprise a proportional solenoid valve which, depending on the pressure measured by the pressure sensor 5a (which can be between 0.01 kPa and 100 kPa) can be configured to maintain the under-pressure for the sucking at a constant or essentially constant level in order to control the suspension distance dₛ between the gripping face 29 and the object 3. Indeed, the pressure level is influenced by the distance between the object 3 and the gripping face 29. A very low pressure (a strong under-pressure) implying that the distance separating the object from the gripping face is too low and that there is a risk of contact, while a too high pressure level (a low sucking under-pressure) indicates that the distance is too great and that there is a risk of releasing the object 3. The under-pressure level measured by the pressure sensor 5a allows providing in real time the pressure measurement to the control unit 4 which adjusts the solenoid valve in order to keep the pressure constant.

The flow sensor 5b can also be used alone or together with the pressure sensor 5a in order to determine the presence of a space between the object and the gripping face. If the object 3 is in contact with the gripping face 29 of the head 28, the air flow through the nozzles 32 can be stopped or very low while a very high flow indicates that the object is no longer gripped. The magnitude of the flow within a range of predetermined values can be used to indicate the presence of a space confirming that the object is gripped by the tool.

In one variant, the control of the distance between the object 3 and the gripping face 29 of the head 28, can be carried out by the control of the power of the ultrasound transducer 10, and therefore of the repulsive force, alone or together with a control of the sucking by the suction system as described above.

The pressure stabilizer 7 can be used to set a safety threshold for the under-pressure in order to prevent the under-pressure from becoming too high, in particular to avoid clogging the nozzles or the suction channels in case of contact between the gripping face 29 and the object. It can therefore be adjusted to prevent damage to the object or the tool, particularly to prevent the introduction of portions of the object in the nozzles and suction channels. The pressure stabilizer can therefore be used by the control tool to set a pressure threshold allowed by the solenoid valve.

In one embodiment, the pressure stabilizer comprises or consists of a resistive orifice 7a which is configured to provide resistance to the air flow greater than the suction channel 30 with the nozzles 32, in particular resistance to air flow at least twice, preferably at least three times greater, preferably at least four times greater than the resistance to the air flow generated by the suction channel 30 together with the nozzle(s) 32. The resistive orifice decreases the slope of increase of the under-pressure (namely the slope of decrease of the pressure) as a function of the inverse of the distance of the object 3 from the gripping face 29, while allowing the suction system to provide a sucking sufficient for the levitation of the object. This reduces the risk of pressing the object against the gripping face, and in case of pressing, reduces the suction force on the object.

The resistive orifice may for example have a cross-sectional surface of half or less of the cross-sectional area of the nozzles 32.

In one variant, the pressure stabilizer may comprise a valve fluidly connected to the suction channel on one side and to ambient air on the other side, the valve opening the connection when the pressure drops below a predetermined threshold configured to let ambient air enter the suction channel in order to increase the pressure (decrease the under-pressure).

A handling system according to one embodiment of the invention may also include the control of a placement table 11 on which the object 3 is gripped and/or placed. There can of course be several placement tables, for example a placement table for gripping the article and a placement table on which the object is deposited, an article to be manufactured being placed on one of the tables for assembling the object. Due to the non-contact levitation of the object 3, the horizontal acceleration is limited, typically to 1 g. In one embodiment, the placement table 11 is controlled in its movement in the horizontal plane, in particular in translation along the two orthogonal axes 13a but also possibly in rotation, while the handling tool 8 is controlled only in vertical translation and possibly in rotation about the vertical axis 13b, in order to accelerate the gripping/placing method.

In one variant, the handling tool 8 can be controlled in vertical translation and also in translation along the horizontal axes in a direction opposite to the direction of translation of the table to increase the relative speed between the table 11 and the tool 8.

The non-contact handling tool 8 comprises an ultrasound transducer 10 to create a repulsion force on the object 3, and a suction system to create an attraction force on the object 3, the attraction and repulsion forces can be balanced in order to suspend the object at a non-zero suspension distance dₛ of one end forming a gripping face 29 of the tool. The attraction and repulsion forces can be varied by the control unit 4 in order to grip the object, move it and release it at a desired location.

The suction system comprises a suction channel 30 passing through the handling tool 8, coupled at one end 21 to the suction device 6 and opening out onto the other end 29 by one or more suction nozzles 32. In one embodiment, as illustrated in FIG. 2c, the suction device comprises a connector 6e, for example in the form of a cap mounted on the end 21 of the transducer and comprising a seal 35, for example comprising an O-ring, encircling the rear body 22 of the transducer. The connector 6e comprises an inlet, for example in the form of a spout 37, in order to connect a pipe connected to the suction pump.

The ultrasound transducer 10 comprises a vibration generator 12 and a transmission device 18 coupled to the generator 12. In the example illustrated, the generator 12 comprises a stack of piezoelectric elements 14, preferably piezoelectric ceramic rings, sandwiched between a rear body 22 and a front body 24 of the transmission device 18. A prestressing member 20, for example in the form of a screw, passes through the central orifices 16 of the piezoelectric rings 14. The prestressing member is configured to apply a tensile force between the rear body 22 and the front body 24 leading to a compressive force acting on the stack of piezoelectric rings sandwiched between these two bodies.

In one advantageous embodiment of the invention, the ultrasound transducer 10 comprises two piezoelectric ceramic rings sandwiched between a rear body 22 and a front body 24 of the transmission device 18. This allows operating at very high frequency in a very compact configuration.

Electrical signals provided by the control circuit 4 to the electrodes of the piezoelectric elements allow generating a periodic axial expansion of the piezoelectric elements 14 to generate ultrasonic waves in the transmission device 18. The general operating principle of an ultrasound transducer 10 with piezoelectric (in particular piezoelectric ceramic) elements sandwiched between a rear body and a front body is known per se. Within the framework of the invention, however, it is possible to use other forms of ultrasound transducer insofar as these are capable of generating the repulsion forces necessary for a non-contact gripping of the object by taking into account the applied suction force. In the example illustrated, the generator advantageously comprises a stack from two to six piezoelectric ceramic rings 14, the piezoelectric rings at the axial ends being oriented so that the neutral electrodes are oriented respectively towards the rear body 22 and the front body 24.

The transmission device 18 comprises the rear body 22, the front body 24 and the prestressing member 20, which may in particular be a screw passing through the rear body 22 and the stack of piezoelectric rings 14 sandwiched between the body rear body 22 and the front body 24. The rear body 22 acts as a reflector for the generated ultrasonic waves, the front body transmitting the waves towards a head 28 disposed at the gripping end of the transmission device 18.

The head 28 comprises an end portion 28a with a gripping face 29 forming the gripping face placed facing the object 3 to be gripped. The end portion 28a comprises the suction nozzles 32 connected to the suction channel 30 and which open out onto the gripping face 29. The ultrasonic waves generated by the generator 12 are emitted by the gripping face 29.

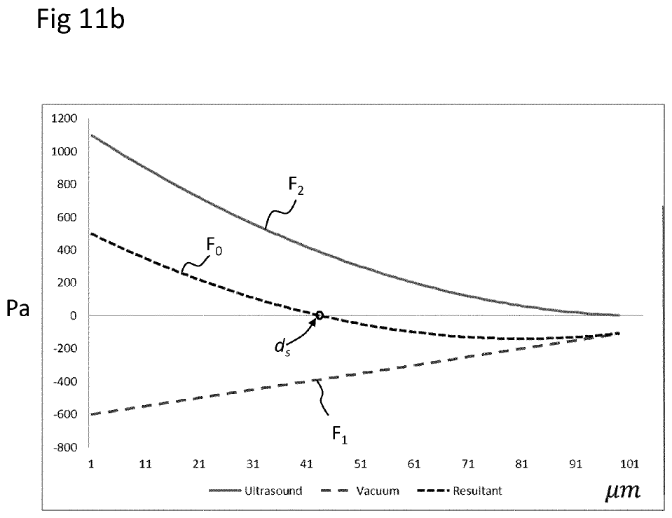

As illustrated in FIGS. 11a and 11b, the ultrasonic waves generate an over-pressure relative to the general ambient pressure, creating a repulsion force F2 on the object 3, while the suction of fluid by the suction nozzle 32 generates an under-pressure relative to the general ambient pressure, create an attraction force F1 on the object 3. The suction force F1 increases when the distance between the object and the gripping face 29 decreases. However, the repulsion force F1 generated by the ultrasound increases when the distance between the object and the gripping face 29 decreases.

The repulsion force is illustrated in FIG. 11c. When considering the near field area (called acoustic Fresnel area), namely in the area 1 where the distance separating the object from the gripping face 29 is much less than λ/4, A being the wavelength of the generated ultrasound, the repulsion force increases rapidly, essentially corresponding to an increase depending on the function. The growth characteristic of the suction force as a function of the distance between the surface of the object 3 and the gripping face 29 is less pronounced such that there is an equilibrium suspension distance dₛ where the suction force F2 is equal to the repulsion force F1 plus the weight of the object (see FIG. 11b).

In examples of application of the invention, the balance distance dₛ between repulsion and attraction forces as a function of the mass and the surface of the object is typically between 1 μm and 80 μm.

Here is an example of a component to be handled and the parameters

| Component | surface | mass | Lifting force |
|---|---|---|---|
| Wheel of a watch | 16 [mm²] | 14 [mg] | 13.72 [mN] |

Pressure at 40 [μm] suspension distance

| | |
|---|---|
| Suction force on a surface of 4[mm²] <= 13.72 [mN], | $P v = \frac{Force}{Area} = \frac{13.72 [ mN ]}{4 [ mm 2 ]} = 3.34 [ kPa ]$ |
| Repulsion Force by ultrasound on a surface of 12[mm²] <= 13.72 | $Pus = \frac{Force}{Area} = \frac{13.72 [ mN ]}{12 [ mm 2 ]} = 1.14 [ kPa ]$ |
| [mN] | |

By varying these two values, the suspension distance dₛ can be changed for example:
if the suction pressure <3.34 [kPa], the suspension distance is greater than 40 μm
if the ultrasonic repulsion pressure <1.14 kPa, the suspension distance is smaller than 40 μm.

These values are typical for components of less than 5 mm.

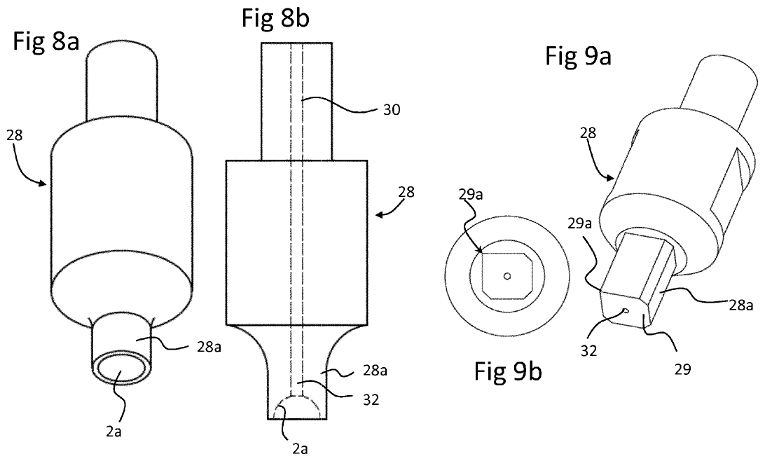

In a preferred embodiment, the head 28 of the transmission device 18 can advantageously be in the form of a part separable from the front body 24, as illustrated in FIGS. 2a-9. This allows changing the head 28 depending on the object 3 to be handled. Indeed, in order to obtain a stable self-centering of the object 3 relative to the non-contact handling tool 8, it is advantageous that the surface of the gripping face 29 is of identical shape and size to the shape and size of the surface of the object 3 facing said gripping face 29, or ranging from 80% to 300% of the size of the surface of the object 3 facing said gripping face 29. A grip, such as a flat part 39, allows unscrewing and screwing the head to the front body

The lateral stability is given mainly by the flow of the fluid around the object towards the suction nozzle(s) 32, the under-pressure acting on the object being configured by the suction nozzle(s) to be of maximum amplitude towards the center of the gripping face 29. In contrast, the over-pressure generated by the near field ultrasound has preferably a characteristic of essentially constant amplitude over the entire gripping face 29 in order to ensure that the surface of the object 3 facing the gripping face 29 is stabilized in a position essentially parallel to this gripping face 29. This results in lateral stability, leading to a centering of the object with respect to the axis A of the handling tool, as well as stability against the rotation of the object about an axis orthogonal to the axis A. This allows keeping the face of the object facing the gripping face 29, at a very low suspension distance constant dₛ, particularly of less than 80μ, more particularly less than 50μ. The very high stability and the very low balance distance (suspension distance) dₛ allow gripping and placing the object extremely accurately.

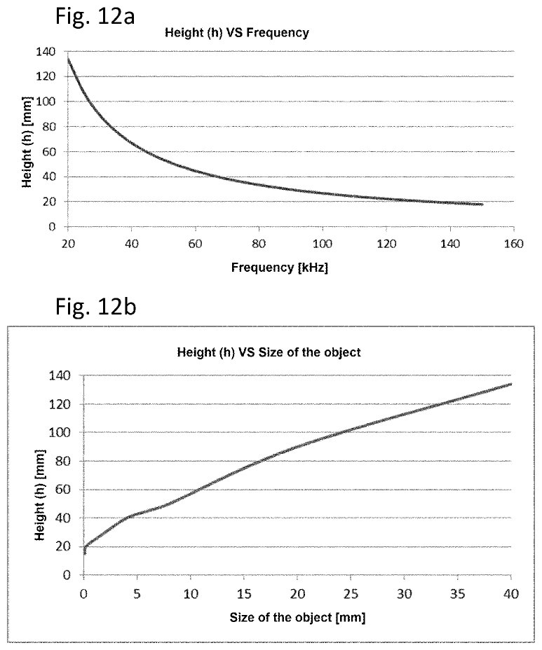

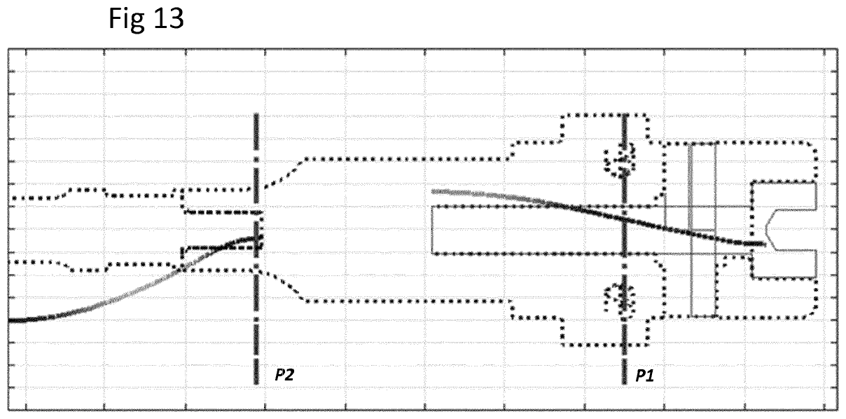

The ultrasound transducer 10, according to the invention, comprises a height h between the end corresponding to the reflective face 21 of the rear body 22 and the end corresponding to the gripping face 29, essentially equivalent to one half wavelength λ/2 of the ultrasound generated inside the ultrasound transducer 10 at the fundamental frequency. The wavelength of the ultrasound generated in the transducer depends on the materials forming the transducer, since the wavelength depends on the speed of sound in the medium concerned. The materials forming the transducer comprise typically aluminum or titanium (or magnesium) alloys for the front body and the head, steel for the rear body (which reflects the waves), and ceramic for the piezoelectric elements. The speed of sound in aluminum is of about 6,200 m/s, while the speed of sound in the air is of about 343 m/s. A transducer with a frontal body and an aluminum head, as well as a piezoceramic generator, operating at a resonant frequency of 50 kHz, has a wavelength at the fundamental frequency of about 100 mm, while the wavelength of the ultrasound emitted to the gripping face in the air is of about 7 mm. The range of materials that can be used for ultrasound generation is now quite limited (aluminum, magnesium, titanium) and the speeds of sound in these materials are comparable, so that the relation between the frequency and the height of the transducer is near or equivalent to the relation illustrated in FIG. 12a. For a fundamental frequency of the transducer of 40 kHz, the height h of the transducer is of about 60 mm, while for a fundamental frequency of 140 kHz, the height h of the transducer is of about 20 mm.

In variants according to the invention, the height h can be ranging from 80% to 140% of said half wavelength λ/2 at the fundamental frequency, in particular be ranging from 90% to 110% of said half wavelength λ/2 at the fundamental frequency.

In devices of the prior art, a sonotrode is coupled to the transducer, the sonotrode corresponding to at least one half wavelength (sometimes more) (at the fundamental frequency) and the transducer corresponding to at least one half wavelength (at the fundamental frequency), the tools of the prior art having a length between ends of at least one wavelength (at the fundamental frequency) of the generated ultrasounds. The space requirement of such tools for applications in tight spaces, in particular for handling very small components (particularly having masses less than 10 gm, or even less than 1 gm), is a drawback and can, depending on the application, make the use of such tools impossible.

In the invention, the integration of the suction system directly into a handling tool provided with the transducer allows having the most compact solution, with a height corresponding to the half wavelength at the fundamental frequency of the ultrasound generated in the transducer.

The operational frequency of the known devices corresponds to the fundamental frequency of the transducer, since the amplitude of the ultrasound generated is maximum at the fundamental frequency.

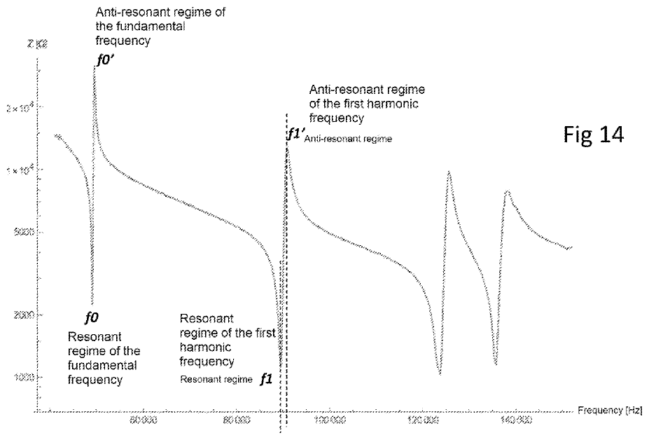

FIG. 14 shows the impedance of the ultrasound generator for a transducer having approximately one half wavelength at the fundamental frequency f0.

According to the invention, the operational frequency of the transducer corresponds to the first harmonic frequency f1 of the transducer. It has been found by the inventors that, surprisingly, it is more advantageous to configure the device in order to work at a frequency regime corresponding to the first harmonic frequency f1 than at the fundamental frequency.

Compared to an operation at the fundamental frequency, the higher frequency of the oscillations of the first harmonic frequency coupled with the amplitude of the oscillations to the gripping face 29, certainly lower, but still sufficiently large, allows improving the stability of grip and providing an optimal ratio between the pushing force and the stability. Indeed, it has been found that one of the sources of instability, in particular for small objects such as millimetric or micrometric objects, is the large amplitude of the oscillations at the fundamental frequency of the transducer. Furthermore, an operation of the handling tool at the first harmonic frequency of the transducer generates higher order deformations (than at the fundamental frequency) at the gripping face 29 which contribute to a distribution of the profile of the more uniform ultrasound in the near field and consequently a more uniform repulsive force, thus contributing to a better stability of grip of the object.

FIG. 13 illustrates the profile of the amplitude of a wave as a function of the axial position in the tool for an operation at the first harmonic frequency of the transducer (the height of the transducer having approximately one half wavelength λ/2 of the ultrasound at the fundamental frequency). At the fundamental frequency, there is only a nodal plane (not illustrated), namely a plane where the amplitude of the wave in the transducer is essentially zero. At the first harmonic frequency, there are however two nodal planes P1, P2, the first P1 towards the back of the transducer and the second P2 towards the head of the transducer. It is advantageously possible to locate the fastening plane of the transducer near or at the level of the first nodal plane P1, and to locate the coupling interface 28b between the head 28 and the front body 24 near or at the level of the second nodal plane P2. This allows reducing the wear of the transducer by reducing the losses due to micro-friction at the interface with the head, and at the same time improving the performance (i.e. increasing the power of the ultrasound) by reducing the energy transmission losses.

A handling device comprising a transducer configured to operate at the first harmonic frequency f1 is very advantageous for a transducer of one half wavelength in height, but can also be implemented with a transducer of one wavelength in height within the framework of this invention.

In the invention, the front body 24 as well as the prestressing member 20 (the screw in the example illustrated) and the ultrasound generator 12 are designed to amplify the amplitude of the generated ultrasound while also maintaining a height as low as possible and integrating the suction system 30, 32, 6e. For this purpose, the front body 24 comprises two, three or more diameter reductions configured to allow amplifying the vibrations in the axial direction A, while minimizing the radial or lateral vibrations (orthogonal to the axial direction), in order to ensure the creation of a stable and uniform ultrasonic pressure wave at the gripping face 29. In one embodiment where there are at least three diameter reductions, for example as illustrated in FIG. 2b, the ratios between the successive diameters D1, D2, D3, D4 in the decreasing direction are ranging:
for D1/D2, between max 2.6 and min 1.1
for D2/D3, between max 2.6 and min 1.1
for D3/D4, between max 6 and min 1.1

and preferably ranging:
for D1/D2, between max 1.6 and min 1.4
for D2/D3, between max 1.6 and min 1.3
for D3/D4, between max 5 and min 1.2

In one embodiment where there are only two diameter reductions in the front body, the ratios between the successive diameters D1, D2, D3, in the decreasing direction are preferably ranging:
for D1/D2, between max 2.6 and min 1.3
for D2/D3, between max 5 and min 1.2

In one embodiment where there are four or more diameter reductions in the front body, the ratios between the successive diameters D1, D2, D3, D4, D5 in the decreasing direction can follow the relations above, the subsequent relations being between max 6 and min 1.1.

In one preferred embodiment, in order to reduce the space requirement of the tool, the non-contact handling system is configured to generate ultrasound in a frequency ranging from 30 to 500 kHz, preferably between 40 and 300 kHz according to the size of the object to be handled. The height of the tool and the frequency used can be defined according to the object to be handled. As illustrated in FIG. 12b, the smaller the object, the lower the tool height can be and the higher the frequency. In the conventional systems, the transducers work typically in a range from 20 to 40 kHz while in the present invention, the combination of a high frequency such as 80 kHz and of a tool having one half wavelength in height of about λ/2 of the fundamental frequency allows reducing the height of the handling tool by 4 to 8 times compared to the conventional tools. In this regard, the fact of working with near field ultrasound for the repulsion force allows decreasing the suction force as well as the power required to generate the ultrasound.

A fastening element, such as a fastening flange 24b, can advantageously be disposed at the position or near the position of the first node plane P1 for fastening the tool to a robot arm or other machine member for the movement of the handling tool. In one embodiment, the fastening element 24b can advantageously comprise a damping coupling to the body 24, configured to damp the residual vibrations in the nodal plane P1.

The suction channel 30, in one embodiment, can advantageously be disposed along the central axis A of the handling tool, the channel having a section 30b passing through the front body and a section 30a passing through the screw 20 for a coupling to the suction device 6. For a handling tool of low height, for example less than 60 mm in height, this is particularly advantageous since it allows facilitating the coupling of the suction device to the tool. However, in variants, it is also possible to dispose the channel otherwise in the body of the handling tool in a non-central manner with a radial inlet into the body of the tool, the critical function of the channel being the disposition of the suction nozzle(s) 32 to the gripping face 29 of the head 28.

In one embodiment, the tool comprises a suction nozzle opening out onto the gripping face, said suction nozzle being centered on the gripping face.

In other embodiments, the tool comprises a plurality of suction nozzles opening out onto the gripping face, said suction nozzles being disposed for example around the center of the gripping face. Examples are illustrated in FIGS. 6 to 7b. A groove 32a can advantageously be disposed in the gripping face 29 at the position of the nozzles 32 so as to better distribute the pressure of the gas flow suctioned around the center of the gripping face. Thus, this prevents excessive location of the under-pressure around the nozzles 32. An example is illustrated in FIG. 7a, 7b.

Still other configurations can be implemented depending on the geometry of the object to be gripped and on the hydrodynamic fluid flow around the object to be gripped. The nozzles are configured to ensure an under-pressure profile allowing attracting the object towards the central axis A of the transmission device in order to laterally stabilize the object relative to the gripping face.

In one embodiment, the head 28 may comprise an end portion 28a configured for the suspension of a liquid drop, the nozzle(s) being configured to create an air or gas flow around the drop controlling the essentially spherical shape of the drop, and dispose on the gripping face 29 a hydrophobic layer to repel the drop when it is very close or when it accidentally comes into contact with the gripping face.

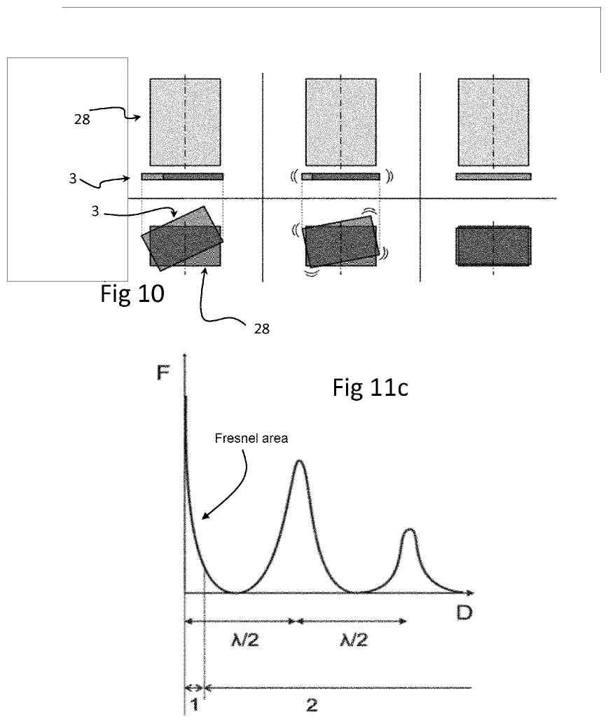

Referring to FIG. 10, when the gripping face 29 of the nozzle has a shape that corresponds to the shape of the object 3, when there is a gripping operation, in particular of a small object, the face of the tool 28 may not be aligned about the vertical axis with the object 3. When the gripping face approaches the object 3, there is a self-centering of the object with the gripping face. However, there are various situations where the objects are not identical and have tolerances, or the tool is used for objects in a range of shape and size where the self-centering effect may not work. There may also be situations (when) where rectangular or polygonal objects with some tolerances randomly align in the wrong orientation, in particular when there are tolerances that make the shape of the object not match identically or very closely to the gripping face of the head.

In order to overcome this problem, in one embodiment, for example as illustrated in FIG. 9, the gripping face 29 comprises a sharp corner 29a and several other rounded corners, namely less sharp than the reference corner 29a. The reference corner 29a allows serving as an alignment reference with a corner of the object to be gripped, so as to ensure proper positioning relative to the gripping face. This solution of having one of the corners of the gripping face sharper than the other ones to serve as an alignment wedge for the object can be applied to rectangular, polygonal, or unevenly shaped gripping faces.

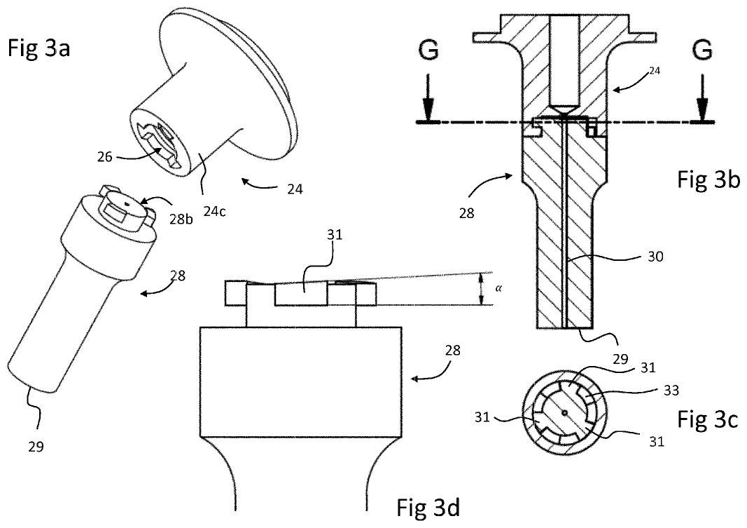

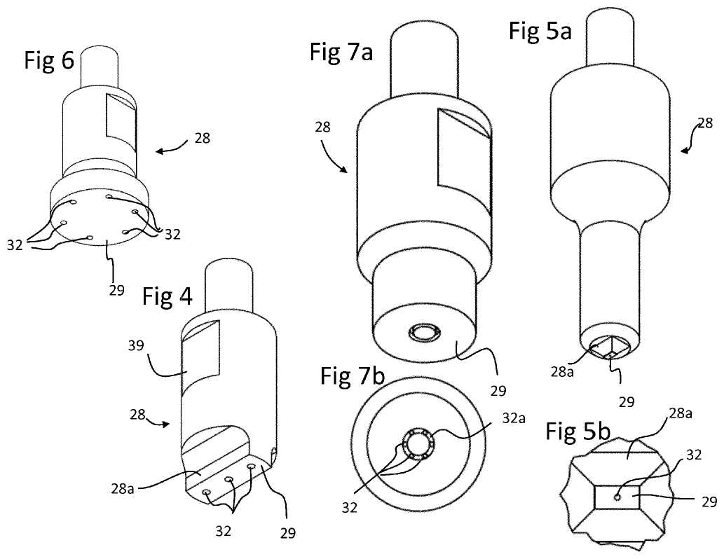

In one embodiment, the head 28 and the front body 24c comprise complementary fastening elements in the form of a bayonet fastening system as illustrated in FIGS. 3a to 3d. The bayonet fastening system comprising lugs 31 on one of the parts inserted into a complementary groove 33 of the other part, as illustrated in FIGS. 3a to 3d. The bayonet fastening allows a quick change of the head, and also ensures accurate angular orientation (about the central axis A) of the head relative to the front body 24 of the handling tool. Indeed, the head can, in some variants, comprise a non-axisymmetric, for example square (see FIG. 9), rectangular (see FIGS. 4 to 5b), oval, polygonal or otherwise shaped gripping face depending on the object to be handled.

The head 28, in a variant, can also be fastened to the front body 24 by means of threaded coupling. Other fastening means, known per se, can also be used in the tool according to the invention.

The handling tool can advantageously comprise a set of several interchangeable heads of different dimensions or shapes to allow changing the head depending on the object to be handled. It should however be noted that, for some applications, the front body and the head may be secured as an integral part.

According to one embodiment, the control unit 4 and the generator 12 can be configured to generate vibrations at an anti-resonant frequency f1′ of the first harmonic frequency, namely at a forced frequency near the resonant frequency f1 of the first harmonic frequency. FIG. 14 graphically shows an electrical impedance curve as a function of the frequency of the ultrasound generator, illustrating a minimum impedance point of the resonant regime f1 and a maximum impedance point of the anti-resonant regime f1′ (forced regime). The points f1 and f1′ are very close in frequency and are associated, the minimum impedance peak being followed by a maximum impedance peak before the decrease of the impedance up to the next harmonic frequency. The advantage of this operating mode and of this configuration is to create a stable vibration. In a resonant system, the low impedance requires a high current and induces a strong deformation of the structure which generates some instability. In order to generate the forced anti-resonant vibrations at positions where the impedance is high or even in the areas where the impedance is maximum, a high voltage is necessary to obtain the amplitude of vibration required to generate the ultrasound, however with a low current. Vibrations in this area are more stable because the structure vibrates in a solid way leading to better stability in the control of the repulsion force of the generated ultrasound. Indeed, by working on forced vibrations, it is possible to vary and control more easily the repulsion force of the ultrasound in the near field. One advantage of a system working with forced vibrations is that the gripping surface 29 vibrates with greater flatness than for a resonant regime, which can improve the gripping stability due to the pressure of a more planar repulsive wave.

In one embodiment, the non-contact handling system may further comprise an electric discharge device 40 (see FIGS. 2d and 2e) in order to remove the electrostatic charges from the objects. The electric discharge device 40 can be separate from the handling tool 8 (FIG. 2e), or integrated into the handling tool (FIG. 2d). The removal of electric charges from the objects allows better controlling the forces acting on the object, in particular in order to remove forces generated by an electrostatic charge from the object. This can also be very advantageous to properly control the balance distance between the object and the gripping face of the tool, thereby increasing the accuracy of gripping and placing the object by the handling system.

In one embodiment, the non-contact handling tool may further comprise a position sensor in order to measure the position, and in particular the distance, of the object relative to the gripping face. The sensor may be in the form of an optical, inductive, capacitive or Hall-effect sensor disposed on the gripping face or around or next to the gripping face. In one embodiment, the position sensor is disposed in the center of the gripping face, the handling tool comprising a plurality of suction nozzles disposed around the sensor. The sensor can be connected to the control circuit of the control unit to control the forces acting on the object, in particular the suction force by controlling for example the power of the suction pump or a valve on the suction channel, and/or by controlling the power of the emitted ultrasound. It can also be very advantageous in order to properly control the balance distance between the object and the gripping face of the tool thus increasing the accuracy of gripping and placing the object by the handling system. The position of the object relative to the gripping face can also be measured by means of one or more cameras that are not part of the handling tool.

It should however be emphasized that the control of the suspension distance dₛ can also be carried out without a position sensor according to embodiments, in particular by controlling the suction under-pressure, this by controlling the suction pump 6a or the valve 6b, according to the pressure measurement given by the pressure sensor 5a.

Taking the direction of the gravitational force as referential, it should be emphasized that the object 3 can be gripped and handled by being disposed below the gripping face 29, but also above the gripping face, or in any other orientation. The vertical direction illustrated in the figures therefore does not necessarily correspond to the direction of the gravitational force since the handling tool according to the invention can suspend an object in all orientations due to the self-centering performed by the suction force relative to the gripping face.

```
Reference list
object 3
non-contact handling system 2
  control unit 4
    power supply of the generator 9
    control circuit
      connection to the suction device
      connection to the sensors
  suction device 6
    suction pump 6a
    regulating valve 6b
    connection line 6d
    suction connector 6e
      seal 35
      spout 37
  sensors 5
    pressure sensor 5a
    flow sensor 5b
    position sensor 5c
    position sensor 5d
  pressure stabilizer 7
    resistive orifice 7a
  non-contact handling tool 8
    ultrasound transducer 10
      generator 12
        stack of piezoelectric rings 14
          central orifice 16
      transmission device 18
        prestressing member 20
          screw
        rear body 22
          reflective face 21
        front body 24
          rear portion 24a
            generator interface
          fastening flange 24b
          head portion 24c
            interface head 26
              groove 33
        head 28
          terminal portion 28a
            gripping face 29
              corner 29a
          body coupling interface 28b
            lug 31
          grip 39
    suction channel 30
      section 30a passing through the screw
      section 30b passing through the front body
      suction nozzle(s) 32
        groove 32a
  placement table 11
  table movement mechanism 13a
  tool movement mechanism 13b
  first nodal plane of the transducer P1
  second nodal plane of the transducer P2
  Axis A
  Height of the transducer h
```

1.-26. (canceled)

27. A non-contact handling tool for gripping an object, the tool comprising an ultrasound transducer configured to emit ultrasound forming, in a near field area of the gripping face, an over-pressure wave and a fluid suction system configured to suction a fluid towards the gripping face, forming in said near field area an under-pressure, wherein the ultrasound transducer is configured to operate at a frequency corresponding to the first harmonic resonant frequency of the transducer or at the first harmonic anti-resonant frequency of the transducer.

28. The non-contact handling tool according to claim 27, wherein the ultrasound transducer extends between a reflective face and a gripping face and has a height (h) defined between the gripping face and the reflective face ranging from 80% to 140% of one half wavelength 212 of the ultrasound generated in the transducer.

29. The non-contact handling tool according to claim 27, wherein the fluid suction system comprises at least one fluid suction channel disposed in the ultrasound transducer, the suction channel comprising one or more suction nozzle(s) opening out onto the gripping face.

30. The non-contact handling tool according to claim 29, wherein said at least one suction channel passes through the handling tool from the gripping face to the reflective face.

31. The non-contact handling tool according to claim 27, wherein the ultrasound transducer comprises an ultrasound generator and an ultrasound transmission device coupled to the generator, the transmission device comprising a front body provided with an element for fastening the tool disposed at a first nodal plane (P1) of the ultrasonic waves generated in the transducer at a frequency corresponding to the first harmonic resonant frequency f1 of the transducer or at a frequency corresponding to the first harmonic anti-resonant frequency f1′ of the transducer.

32. The non-contact handling tool according to claim 27, wherein the ultrasound transducer comprises a head interchangeably coupled to a front body of the transmission device by a fastening device, the gripping face being disposed on the head, a second nodal plane of the ultrasonic waves generated in the transducer at a frequency corresponding to the first harmonic resonant frequency f1 of the transducer or at a frequency corresponding to the first harmonic anti-resonant frequency f1′ of the transducer.

33. The non-contact handling tool according to claim 32, comprising a set of several interchangeable heads of different dimensions or shapes.

34. The non-contact handling tool according to claim 32, wherein the fastening device comprises complementary fastening elements on the head and the front body in the form of a bayonet or screw fastening system.

35. The non-contact handling tool according to claim 27, wherein the front body comprises at least two successive diameter reductions D1, D2, D3 in the direction of the ultrasound generator towards the gripping face, the ratios between the successive diameters D1, D2, D3 in said direction ranging:
for D1/D2, between max 2.6 and min 1.1
for D2/D3, between max 6 and min 1.1
and for any additional reduction between max 6 and min 1.1.

36. The non-contact handling tool according to claim 35, wherein the transmission device comprises a rear body and a prestressing member, the ultrasound generator being compressed between the front body and the rear body by the prestressing member, the ultrasound generator comprising for example a stack of a plurality of piezoelectric rings.

37. The non-contact handling tool according to claim 36, wherein the prestressing member is a screw, the suction channel passing through the screw.

38. The non-contact handling tool according to claim 27, wherein the gripping face is ranging from 0.01 to 650 mm² and is planar, or has a curved, for example concave, shape configured to conform to a portion of the surface of the object to be gripped.

39. A non-contact handling system comprising a non-contact handling tool according to claim 27, a control unit connected to an ultrasound generator of the ultrasound transducer, and a suction device comprising a suction pump connected to the suction fluid channel, the control unit and the ultrasound transducer being configured to generate ultrasound in the transducer at a first harmonic resonant frequency of the transducer or at a first harmonic anti-resonant frequency of the transducer.

40. The non-contact handling system according to claim 39, wherein the control unit and the ultrasound transducer are configured to generate ultrasound at a frequency ranging from 20 kHz to 350 kHz, preferably ranging from 40 kHz to 350 kHz.

41. The non-contact handling system according to claim 39, wherein the control unit comprises a control circuit connected to the ultrasound generator and to the suction pump for simultaneously controlling the suction power and the ultrasound generation.

42. The non-contact handling system according to claim 39, wherein the suction device comprises a solenoid valve and a pressure sensor connected to the control unit, the solenoid valve being regulated by the pressure measured by the pressure sensor in order to control a distance of suspension dₛ of the object relative to the gripping face.

43. The non-contact handling system according to claim 39, wherein it comprises a pressure stabilizer fluidly coupled to the suction channel to limit an exceeding of an under-pressure threshold in order to avoid a too strong sucking.

44. The non-contact handling system according to claim 43, wherein the pressure stabilizer comprises or consists of a resistive orifice which is configured to provide resistance to air flow greater than the suction channel, in particular a resistance to air flow at least twice, preferably at least three times, preferably at least four times greater than the resistance to air flow generated by the suction channel together with the nozzle(s).

45. The non-contact handling system according to claim 39, wherein it comprises a flow sensor measuring the air flow in the suction channel connecting the tool to the suction pump, the flow detector being configured to detect the contact of the object with the gripping face, or to detect too high flow indicating that the object is no longer in engagement with the tool.

46. A method for non-contact handling of an object, comprising:
providing a non-contact handling system comprising a non-contact handling tool according to claim 27, a control unit connected to an ultrasound generator of the ultrasound transducer, and a suction device comprising a suction pump connected to the fluid suction channel,
activating the suction pump to create a suction force and the ultrasound generator to create a repulsion force, relative to the gripping face, the ultrasound generator being controlled by the control unit to generate ultrasound in the transducer at a first harmonic resonant frequency of the transducer or at a first harmonic anti-resonant frequency,
placing the gripping face of the handling tool in front of a surface of the object at a distance ranging from 0.5 to 6 times the suspension distance dₛ,
suspending the object at a non-zero suspension distance with respect to the gripping face by controlling the suction device and/or the ultrasound generator, the suspension distance being controlled to be in a near field area of the ultrasound.

47. The non-contact handling method according to claim 46, wherein the ultrasound transducer is configured and controlled to generate ultrasound at a frequency ranging from 20 kHz to 350 kHz, preferably ranging from 40 kHz to 350 kHz.

48. The non-contact handling method according to claim 46, wherein said suspension distance is between 1 and 80 micrometers, preferably between 1 and 60 micrometers, particularly between 5 and 50 micrometers.

49. The non-contact handling method according to claim 46, wherein the transducer is operated at a forced anti-resonant frequency.

50. The non-contact handling method according to claim 46, wherein the suction device comprises a solenoid valve and a pressure sensor connected to the control unit, the solenoid valve being regulated by the pressure measured by the pressure sensor in order to regulate a distance of suspension dₛ of the object relative to the gripping face.

51. The non-contact handling method according to claim 46, wherein the suction device comprises a pressure stabilizer fluidly coupled to the suction channel, the stabilizer limiting the exceeding of an under-pressure threshold in order to avoid sucking of foreign matter coming from the object in nozzles or in the suction channel.

52. The non-contact handling method according to claim 46, wherein the suction device comprises a flow sensor measuring the air flow in the suction channel connecting the tool to the suction pump in order to detect a contact of the object with the gripping face or to detect a too high flow indicating that the object is no longer in engagement with the tool.
